(19) United States
(12) Patent Application Publication
(10) Pub. No.: US 2026/0209430 A1
(43) Pub. Date: Jul. 23, 2026

(54) PROCESS FOR THE SYNTHESIS OF POLYESTEROLS BY RING-OPENING CO-POLYMERISATION OF GAMMA-BUTYROLACTONE WITH OTHER LACTONES

(71) Applicant: BASF SE, Ludwigshafen am Rhein (DE)

(72) Inventors: Thomas SCHAUB, Ludwigshafen am Rhein (DE); Mathieu NICOLAS, Lyon (FR); Alban FALCONNET, Heidelberg (DE); A.Stephen K. HASHMI, Heidelburg (DE); Rupert KONRADI, Ludwigshafen am Rhein (DE); Dieter RODEWALD, Ludwigshafen am Rhein (DE); Bernd BRUCHMANN, Freinsheim (DE)

(21) Appl. No.: 19/135,847

(22) PCT Filed: Dec. 5, 2023
(86) PCT No.: PCT/EP2023/084202

§ 371 Date: Jun. 5, 2025

(30) Foreign Application Priority Data
Dec. 7, 2022 (EP) 22212019.8

(51) Int. Cl. C08G 63/82; C08G 63/08; C08G 63/81; C08G 63/83

(52) U.S. Cl. CPC C08G 63/823; C08G 63/08; C08G 63/81; C08G 63/83

(57) ABSTRACT

Described are a process for the synthesis of polyesterols by ring-opening co-polymerisation of γ-butyrolactone with other lactones, the use of a kit comprising one or more bases comprising an alkaline metal cation and one or more alcohols in said process, and polyesterols obtainable by said process.

The present application relates to a process for the synthesis of polyesterols by ring-opening co-polymerisation of γ-butyrolactone with other lactones, to the use of a kit comprising one or more bases comprising an alkaline metal cation and one or more alcohols in said process, and to polyesterols obtainable by said process.

Polyesterols are an important class of polyols which for example are used in the synthesis of polyurethanes. Especially γ-butyrolactone is a highly attractive monomer for the synthesis of polyesterols by ring-opening polymerization since it is a cheap easily available material which can be obtained from biomass feedstock. This provides access to a polymer which is not only biodegradable, but also obtainable from renewable resources. Due to the low strain energy of the five membered ring of γ-butyrolactone is not easily polymerized, compared to other easy to polymerize lactones as e.g. caprolactones (see: Q. Song et al., Polymer Journal, 2020, 52, 3-11). Interestingly, the ring-opening co-polymerization of γ-butyrolactone with other lactones proceeds more straightforward and can deliver products which are liquid at room temperature (see: Q. Song et al., Progress in Polymer Science, 2020, 110, 101309).

Certain progress was made in the last years due to the development of catalyst/initiator systems which are capable of co-polymerizing γ-butyrolactone with other lactones to polyesterols. However, usually harsh reaction conditions using Lewis acidic catalysts are required, the catalysts are rather elaborated, no polyols are obtained, or the obtained yield is only moderate, and the reaction is to be carried out in a relatively diluted solution which is unfavorable from an economic perspective.

EP 1 041 099 A2 discloses the use of BF₃*Et₂O as initiator for the co-polymerization of γ-butyrolactone with ε-caprolactone resp. δ-valerolactone at a temperature of 130° C. and a pressure of 1.25 GPa to a polyester having a weight average molecular weight (M_{w}) of 31,700 g/mol resp. 14,600 g/mol at a yield of 85% resp. 76%. The required high pressure is a significant drawback as it would require expensive high-pressure equipment to run the co-polymerization. It could also not be shown if the obtained product is a polyol.

Macromol. Chem. Phys. 1996, 197, 1273-1283, describes the co-polymerization of γ-butyrolactone with ε-caprolactone in different ratios at a temperature of 20° C. and atmospheric pressure using Al(OiPr)₃ as initiator. The obtained polyesters have an average molecular weight (Mₙ) between 950 g/mol and 33,100 g/mol. A drawback of this process is that at least one end of the polymer chain of the obtained polyester is terminated by the OiPr-group from the initiator. Therefore, the obtained polyester is not a diol and cannot be used as a polyol in polyurethane synthesis.

Polymer, 1998, 39, 1213-1222, describes the co-polymerization of γ-butyrolactone with different lactones as ε-caprolactone, δ-valerolactone, β-propiolactone or glycolide in different ratios at 140° C. using tetraphenyl tin as the initiator. However, the highest fraction of building units derived from γ-butyrolactone in the obtained polyester co-polymer which could be achieved by means of this process was 26 mol %, even if a large excess of γ-butyrolactone (5 equivalents compared to the other lactone) was used. Another major drawback of this process is the use of organo-tin compounds, which are generally compounds of concern due to their toxicity.

Polymer, 2005, 46, 12118-12129, describes the co-polymerization of γ-butyrolactone with ε-caprolactone in different ratios at 150° C. using decamolybdate as the catalyst. However, the highest fraction of building units derived from γ-butyrolactone in the obtained polyester co-polymer which could be achieved by means of this process was 10 mol %, even if a 1:1 molar ratio of γ-butyrolactone: ε-caprolactone was used. Accordingly, a significant amount of the γ-butyrolactone remains unreacted.

J. Mater. Chem. B. 2016, 4, 5394-5404, describes the co-polymerization of γ-butyrolactone with ε-caprolactone in different ratios at 110° C. using dioctyltin as catalyst and ethylene glycol as initiator. Due to the use of a diol as initiator, a polyol was obtained which could be used further in the synthesis of polyurethanes. However, the highest fraction of building units derived from γ-butyrolactone in the polyester co-polymer which could be achieved by means of this process was 11 mol %, even if a 6:4 molar ratio of γ-butyrolactone:ε-caprolactone was used. Accordingly, a significant amount of the γ-butyrolactone remains unreacted. A further major drawback of this process is the use of organo-tin catalysts, which are generally compounds of concern due to their toxicity.

Polym. Chem. 2018, 9, 2936-2941, describes the co-polymerization of γ-butyrolactone with L-Lactide in different ratios at −50° C. to +25° C. using a phosphazene base as the catalyst and benzylic alcohol as the initiator. Due to the use of a mono-alcohol benzylalcohol as initiator, at least one end of the polymer chain of the obtained polyester is terminated by the benzylic group from the initiator. Therefore, the obtained polyester is not a diol and cannot be used as a polyol in polyurethane synthesis. Also, the use of the expensive and sensitive phosphazene base is a drawback of this process.

Macromolecules, 2017, 50, 8469-8479, describes the co-polymerization of γ-butyrolactone with ε-caprolactone and δ-valerolactone, in different ratios at −40° C. to +25° C. using a phosphazene base or La(N(SiMe₃)₂)₃ as catalyst and a mono-alcohol as the initiator. Due to the use of a mono-alcohol as initiator, at least one end of the polymer chain of the obtained polyesterol is not terminated by a hydroxy group. Therefore, the obtained polyester is not a diol and cannot be used as a polyol in polyurethane synthesis. Also, the use of the expensive and sensitive phosphazene base or of La(N(SiMe₃)₂)₃ is a serious drawback of this process.

CN 114369232 A discloses an ABA triblock copolymer and a method for its preparation using γ-butyrolactone (γ-BL), α-methylene-γ-butyrolactone (MBL), ε-caprolactone (ε-CL), δ-valerolactone (δ-VL), lactide (LA) and other biomass monomers as raw materials and a binary catalytic system composed of strong base and cocatalyst.

CN 108250415 A discloses a poly(γ-butyrolactone)-b-polylactic acid block copolymer and preparation method thereof.

P. Walther and S. Naumann (Macromolecules 2017, 50, 8406-8416) disclose a dual catalytic approach using a setup consisting of N-heterocylic olefins (NHOs) and Lewis acids (such as MgCl₂ or LiCl) to homopolymerize ω-pentadecalactone (PDL) and to copolymerize it with five-, six-, and seven-membered lactones (γ-butyrolactone (GBL), 5-valerolactone (VL), and ε-caprolactone (CL)). Also the copolymerization of GBL with VL and CL was investigated.

W0 2022/122360 A1 discloses a composition for producing polyurethane foam, in particular rigid polyurethane foam, comprising at least one isocyanate component, a polyol component, optionally a catalyst that catalyzes the formation of a urethane or isocyanurate bond, and a blowing agent, the composition comprising polyester poly siloxane block copolymers.

It was a primary object of this invention to provide a process for the synthesis of polyesterols by ring-opening co-polymerization of γ-butyrolactone with other lactones which can be performed using a simple, easily accessible, and cheap catalyst, wherein the process provides polyesterols in high yields with the possibility to achieve incorporation of 20 mol % or more, preferably of 30 mol % or more, more preferably of 40 mol % or more of γ-butyrolactone in the copolymer. It was a further object to provide a process for ring-opening copolymerization of γ-butyrolactone with other lactones which does not require very high temperatures (above 50° C.) or very low temperatures (below −25° C.), so that cheaper equipment and less energy is needed.

The primary object and other objects of the present invention are accomplished by a process for the synthesis of polyesterols,
comprising the step of ring-opening co-polymerization of lactones,
wherein said lactones are
(i)

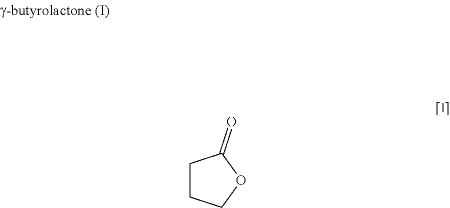

and
(ii) one or more lactones of formula (II)

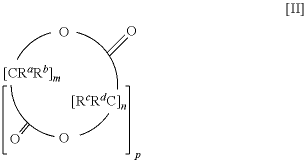

wherein
m is an integer selected from 1 to 12
n is an integer selected from 1 to 2,
each Rₐ, each R_{b}, each R_{c} and each Rₐ is independently selected from the group consisting of H and C₁-C₁₀-alkyl
p is an integer selected from 0 and 1
with the proviso that m is not 3 when p=0
wherein the ring-opening co-polymerization is carried out in the presence of
(iii) one or more bases comprising an alkali metal cation and
(iv) one or more alcohols
at a temperature from −25° C. to +50° C.,
wherein the molar ratio of
the total amount of lactones (i) and (ii)
to the total amount of bases (iii) comprising an alkali metal cation

((i)+(ii)):(iii)
is 50:1 or higher.

In the process according to the invention, (i) γ-butyrolactone (I) is copolymerized with (ii) one or more lactones of formula (II) as defined above, preferably with one lactone of formula (II) as defined above.

A lactone according to formula (II) comprises m groups CR^{a}R^{b} wherein m is an integer selected from 1 to 12. Thus, a lactone according to formula (II) comprises 1 to 12 groups CR^{a}R^{b}. In addition, a lactone according to formula (II) comprises p groups —(C═O)—O—[CR^{c}R^{d}]ₙ, wherein p is an integer selected from 0 and 1 and n is an integer selected from 1 and 2. Thus, a lactone according to formula (II) comprises one group —(C═O)—O—[CR^{c}R^{d}]ₙ comprising one or two groups [CR^{c}R^{d}], or no group —(C═O)—O—[CR^{c}R^{d}]ₙ.

As defined above, when in formula (II) p=0 then m must not be 3. Thus, it is understood that γ-butyrolactone (I) is not a lactone according to formula (II) as defined above.

A molecule of formula (II) has m groups CR^{a}R^{b} and n groups CR^{c}R^{d}. Each of the m substituents Rₐ, m substituents R_{b}, n substituents R_{c} and n substituents R^{d} is selected independently from the group consisting of H and C₁-C₁₀-alkyl. As used herein, C₁-C₁₀-alkyl is intended to include linear C₁-C₁₀-alkyl as well as branched C₄-C₁₀-alkyl alkyls, and more specifically n-C₁-C₁₀-alkyl, sec-C₃-C₁₀-alkyl as well as tert-C₄-C₁₀-alkyl.

Preferably, the lactone according to formula (II), or one or more or all of the lactones according to formula (II) are selected from the group consisting of ε-caprolactone, ε-decalactone, δ-valerolactone, β-propiolactone, lactide and glycolide. Further preferably, γ-butyrolactone (I) is co-polymerized with one lactone according to formula (II) selected from the group consisting of ε-caprolactone, ε-decalactone, δ-valerolactone, β-propiolactone, lactide and glycolide.

In ε-caprolactone, p=0, m=5, and each R^{a} and each R^{b} is H.

In ε-decalactone, p=0, and m=5, in the 1^{st} to 4^{th} (counting started with the group CR^{a}R^{b} closest to the carbonyl group) CR^{a}R^{b} group both of R^{a} and R^{b} are H, and in the 5^{th} CR^{a}R^{b} group R^{a} is H and R^{b} is C₄H₉.

In δ-valerolactone, p=0, m=4, and each Rₐ and each R_{b} is H.

In β-propiolactone, p=0, m=2 and each Rₐ and each R_{b} is H.

In lactide, p=1, n=m=1, each of R^{a} and R^{c} is H, and each of R^{b} and R^{d} is CH₃.

In glycolide, p=1, n=m=1, and each of R^{a}, R^{b}, R^{c} and R^{d} is H.

Most preferred lactones of formula (II) are those selected from the group consisting of ε-caprolactone, ε-decalactone, and δ-valerolactone.

In the process according to the invention, the ring-opening co-polymerization is carried out at a temperature in the range of from −25° C. to +50° C., preferably at a temperature in the range of from −25° C. to +30° C., more preferably −25° C. to +20° C., and most preferably at a temperature in the range of from −25° C. to +10° C.

In the process according to the invention, the ring-opening co-polymerization is typically carried out at ambient pressure.

In the process according to the invention, the ring-opening co-polymerization is carried out in the presence of
(iii) one or more bases comprising an alkali metal cation and
(iv) one or more alcohols

Without wishing to be bound by any theory, it is presently assumed that the base (iii) acts as a catalyst for the ring-opening co-polymerization of (i) γ-butyrolactone (i) and (ii) said one or more lactones of formula (II), and the alcohol (iv) acts as an initiator for the ring opening co-polymerization of (i) γ-butyrolactone and (ii) said one or more lactones of formula (II).

In the process according to the invention, the molar ratio of the total amount of lactones (i) and (ii) to the total amount of bases (iii) comprising an alkali metal cation

((i)+(ii)):(iii)

is 50:1 or higher. Preferably, the molar ratio of the total amount of lactones (i) and (ii) to the total amount of bases (iii) comprising an alkali metal cation is in the range of from 100:1 to 800:1, preferably 100:1 to 400:1. Thus, the amount of base (iii) required as catalyst for the ring-opening co-polymerization of a given amount of lactones (i) and (ii) is rather low, which is favorable from an economic point of view.

The base (iii) is a base comprising an alkali metal cation. The anion of the base (i) may be a proton acceptor (Brønsted base) and/or an electron pair donator (Lewis base). Preferably, the alkali metal cation is selected from the group consisting of Li⁺, Na⁺, K⁺, Rb⁺ and Cs⁺, most preferably from the group consisting of Li⁺, Na⁺ and K⁺.

Preferably, the base (iii) comprising an alkali metal cation, or one or more or all of the bases (iii) comprising an alkali metal cation are selected from the group consisting of lithium alkoxides, sodium alkoxides and potassium alkoxides. The alkoxides can be derived from a monool, a diol or a triol. More preferably, the base (iii) comprising an alkali metal cation, or one or more or all of the bases (iii) comprising an alkali metal cation are selected from the group consisting of lithium methoxide, sodium methoxide, potassium methoxide, lithium tertbutoxide, sodium tertbutoxide, potassium tertbutoxide, lithium benzylalcoholate, sodium benzylalcoholate, potassium benzylalcoholate, di potassium benzenedimethanol and disodium benzenedimethanol.

More preferably, each base (iii) comprising an alkali metal cation is selected from the group consisting of lithium alkoxides, sodium alkoxides and potassium alkoxides, preferably from the group consisting of lithium methoxide, sodium methoxide, potassium methoxide, lithium tertbutoxide, sodium tertbutoxide, potassium tertbutoxide, lithium benzylalcoholate, sodium benzylalcoholate and potassium benzylalcoholate.

The most preferred bases (iii) are lithium tertbutoxide, sodium tertbutoxide, potassium tertbutoxide and potassium benzylalcoholate.

Preferably, the alcohol (iv) or one or more or all of the alcohols (iv) are selected from monools, diols, triols and tetraols. However, in certain cases, especially for producing polyesterols which are suitable for the synthesis of polyurethanes, it is preferred that the alcohol (iv) is not a monool.

Preferably, the alcohol (iv) or one or more or all of the alcohols (iv) are selected from the group consisting of ethyleneglycol, diethyleneglycol, polyethyleneglycol (PEG), 1,2-propanediol, dipropyleneglycol, polypropyleneglycol, 1,3-propanediol, 1,4-butanediol, neopentylglycol, polytetra-methyleneglycol, 1,5-pentanediol, 1,6-hexanediol, glycerol, trimethylolpropane, trimethylolethane, pentaerythritol, mannitol, sorbitol, xylitol, threitol, and benzylic alcohols according to formula (III)

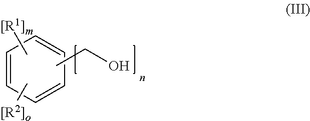

wherein
n is an integer from 1 to 4, preferably 2 or 3
m is an integer from 0 to 3,
is 0 or 1

$$m + n + o \leq 6 ;$$

R¹ and R² are independently of one another selected from the group consisting of
F, Cl, Br, OH, CN, NH₂, NO₂,
C₁-C₁₀-alkyl
C₃-C₁₀-cycloalkyl,
C₃-C₁₀-heterocyclyl comprising at least one heteroatom selected from N, O and S, C₅-C₁₄-aryl,
C₅-C₁₀-heteroaryl comprising at least one heteroatom selected from N, O and S,
wherein said C₁-C₁₀-alkyl, C₃-C₁₀-cycloalkyl, C₃-C₁₀-heterocyclyl, C₅-C₁₄-aryl, resp. C₅-C₁₀-heteroaryl optionally has one or more further substituents selected from the group consisting of: F, Cl, Br, OH, CN, NH₂ and C₁-C₁₀-alkyl, wherein the benzylic alcohol according to formula (III) is preferably selected from the group consisting of benzylic alcohol, 1,4-benzenedimethanol, 2,6-dichlorobenzylalcohol, 4-methylbenzylalcohol and 2,4,6-trimethylbenzylalcohol.

As used herein, C₁-C₁₀-alkyl is intended to include linear C₁-C₁₀-alkyl as well as branched C₄-C₁₀-alkyl alkyls, and more specifically n-C₁-C₁₀-alkyl, sec-C₃-C₁₀-alkyl as well as tert-C₄-C₁₀-alkyl.

More preferably, each alcohol (iv) is selected from the above-defined group.

Among benzylic alcohols according to formula (III), 1,4-benzenedimethanol, 2,6-dichlorobenzylalcohol, 4-methylbenzylalcohol and 2,4,6-trimethyl-benzylalcohol are preferred.

The most preferred alcohols (iv) are methanol, ethanol, polyethyleneglycol (PEG), 1,4-butanediol, 1,6-hexanediol, benzylic alcohol, 1,4-benzenedimethanol, 2,6-dichlorobenzylalcohol, 4-methylbenzylalcohol and 2,4,6-trimethylbenzylalcohol.

Most preferably the base (iii) comprising an alkali metal cation or one or more of the bases (iii) comprising an alkali metal cation are selected from the above-defined group of preferred bases (iii), and the alcohol (iv) or one or more of the alcohols (iv) are selected from the above-defined group of preferred alcohols (iv). More preferably, each base (iii) comprising an alkali metal cation is selected from the above-defined group of preferred bases (iii), and each alcohol (iv) is selected from the above-defined group of preferred alcohols (iv).

### In a Specifically Preferred Process,

(iii) said base comprising an alkali metal cation or one, more or all of the bases (iii) comprising an alkali metal cation are selected from alkali metal alkoxides of the formula MOR³ wherein M is selected from the group consisting of Li, Na and K
(iv) said alcohol or one, more or all of the alcohols (iv) are selected from alcohols of the formula R³OH
   wherein R³ of (iii) is identical to R³ of (iv) and is preferably selected from the group consisting of methyl, ethyl, isopropyl, sec-butyl, tert-butyl and benzyl.

In the process according to the invention, the molar ratio of the total amount of bases (iii) comprising an alkali metal cation to the total amount of OH groups (v) in the alcohols (iv)

(iii):(v)
is preferably in the range from 1:6 to 12:1, more preferably of from 1:2 to 8:1.

In the process according to the invention, the molar ration of (i) γ-butyrolactone to (ii) lactones according to formula (II) can be varied, resulting in a variation of the molar ratio of building units derived from (i) γ-butyrolactone (I) to building units derived from (ii) the one or more lactones according to formula (II) in the final polyesterol. Thus, it is possible to adjust the properties of the polyesterol to be obtained. For example, the molar ratio of building units derived from (i) γ-butyrolactone to building units derived from (ii) lactones according to formula (II) may have a strong influence on the melting point or glass transition temperature of the obtained polyesterol. Preferably, in the process according to the invention, the molar ratio of (i) γ-butyrolactone (I) to (ii) the total amount of (ii) lactones of formula (II)

(i):(ii)
is in a range of from 5:95 to 95:5, more preferably of from 85:15 to 15:85.

In the process according to the invention, the ring opening co-polymerization is usually carried out in a reaction mixture comprising the reactants (i), (ii), catalyst (iii), and initiator (iv). Thus, a reaction mixture comprising the reactants (i), (ii), catalyst (iii) and initiator (iv) may be provided for the process according to the invention.

In certain cases, it is preferred that the ring-opening co-polymerization is carried out in a solvent or in one or more solvents. Suitable solvents are those in which reactants (i) and (ii), the catalyst (iii) and the initiator (iv) as well as the product polyesterol are soluble resp. with which they are mixable. Thus, the co-polymerization is carried out in a reaction mixture comprising the reactants (i), (ii), catalyst (iii), initiator (iv) and a solvent. The presence of one or more solvents in the reaction mixture enables homogeneous distribution of the reactants (i), (ii), (iii) and (iv) as defined above and facilitates their interaction. Thus, in said cases a reaction mixture comprising the reactants (i), (ii), catalyst (iii), initiator (iv) and one or more solvent is usually provided for the process according to the invention.

Preferably the solvent or one or more or all of the solvents are selected from the group consisting of aliphatic hydrocarbons, aromatic hydrocarbons, ethers, esters, N,N-dialkylamides, dialkylsulfoxides and nitriles. More preferably, each solvent is selected from the group consisting of aliphatic hydrocarbons, aromatic hydrocarbons, ethers, esters, N,N-dialkylamides, dialkylsulfoxides and nitriles.

As used herein, the term “hydrocarbons” is intended to include halogenated hydrocarbons.

Further preferably, the solvent or one, more or all of the solvents are selected from the group consisting of dichloromethane, toluene, 2-methyl-tetrahydrofurane, 1,4-dioxane, glyme, diglyme, ethyl acetate, dimethylformamide, dimethylsulfoxide and acetonitrile. Most preferably, each solvent is selected from the group consisting of dichloromethane, toluene, 2-methyl-tetrahydrofurane, 1,4-dioxane, glyme, diglyme, ethyl acetate, dimethylformamide, dimethylsulfoxide and acetonitrile.

### For the Ring Opening Co-Polymerization

a premix comprising (i) γ-butyrolactone (I) and (ii) one or more lactones of formula (II) as defined above and optionally one or more solvents, and
a premix comprising (iii) one or more bases comprising an alkali metal cation and (iv) one or more alcohols and one or more solvents may be provided.

In the process according to the invention, a reaction mixture may be formed and the ring-opening co-polymerization may be initiated by addition of a first premix comprising (iii) one or more bases comprising an alkali metal cation and (iv) one or more alcohols and one or more solvents to a second premix comprising (i) γ-butyrolactone (I) and (ii) one or more lactones of formula (II) as defined above and optionally one or more solvents.

### After the Ring-Opening Co-Polymerization is Initiated,

one or more further portions of a premix comprising (iii) said one or more bases comprising an alkali metal cation and (iv) said one or more alcohols and one or more solvents as in the above-mentioned first premix and/or
one or more further portions of a premix comprising (i) γ butyrolactone (I) and (ii) said one or more lactones of formula (II) as defined above and optionally one or more solvents as in the above-mentioned second premix, may be added.

Said one or more further portions of a premix comprising (iii) said one or more bases comprising an alkali metal cation and (iv) said one or more alcohols and one or more solvents may contain said base (iii) and said one or more alcohols (iv) in the same molar ratio as in the above-mentioned first premix, or in a different molar ratio.

Said one or more further portions of a premix comprising (i) γ-butyrolactone (I) and (ii) one or more lactones of formula (II) as defined above may contain (i) γ-butyrolactone (I) and (ii) said one or more lactones of formula (II) in the same molar ratio as in the above-mentioned second premix, or in a different molar ratio, for the sake of adjusting the molar ratio of (i) γ-butyrolactone (I) and (ii) one or more lactones of formula (II) as defined above in the copolymer to be formed.

In certain cases, for reducing the complexity of the process it may be preferred that no further portions of a premix comprising (iii) said one or more bases comprising an alkali metal cation and (iv) said one or more alcohols and one or more solvents, and no further portions of a premix comprising (i) γ butyrolactone (I) and (ii) said one or more lactones of formula (II) as defined above and optionally one or more solvents are added after the ring-opening co-polymerization is initiated.

The solvent or one or more or all of the solvents are preferably selected from the group consisting of aliphatic hydrocarbons, aromatic hydrocarbons, ethers, esters, N,N-dialkylamides, dialkylsulfoxides and nitriles, most preferably from the group consisting of dichloromethane, toluene, 2-methyl-tetrahydrofurane, 1,4-dioxane, glyme, diglyme, ethyl acetate, dimethylformamide, dimethylsulfoxide and acetonitrile. More preferably, each solvent is selected from the group consisting of aliphatic hydrocarbons, aromatic hydrocarbons, ethers, esters, N,N-dialkylamides, dialkylsulfoxides and nitriles, most preferably from the group consisting of dichloromethane, toluene, 2-methyl-tetrahydrofurane, 1,4-dioxane, glyme, diglyme, ethyl acetate and acetonitrile.

In certain cases, the above-defined process further comprises prior to the ring-opening copolymerization a step of drying of the lactones (i) and (ii) by adding a drying agent, and optional separation of the dried lactones (i) and (ii) from the drying agent. Drying can be achieved by means of any suitable drying agent.

The drying agent is preferably selected from the group consisting of selected from the group consisting of
CaH₂,
tosyl isocyanate,
and oxazolidines.

The oxazolidine is preferably selected from the group consisting of oxazolidines of formula (III), oxazolidines of formula (IV), and oxazolidines of formula (V)

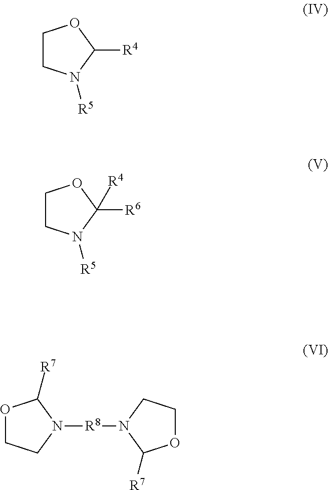

wherein
R⁴, R⁵, R⁶, and R⁷ are independently of one another selected from the group consisting of H— and C₁-C₁₀-alkyl
and R⁸ is a bridging unit comprising 1 to 20-CH₂-units (methylene units) and optionally one or more moieties selected from the group consisting of
—NH—,
O— (ether bridge),
—CO—(carbonyl)
—COO— (carboxyl)
and —NH—COO— (urethane).

As used herein, C₁-C₁₀-alkyl is intended to include linear C₁-C₁₀-alkyl as well as branched C₄-C₁₀-alkyl alkyls, and more specifically n-C₁-C₁₀-alkyl, sec-C₃-C₁₀-alkyl as well as tert-C₄-C₁₀-alkyl.

In certain preferred oxazolidines of formula (VI), the bridging unit R⁸ is

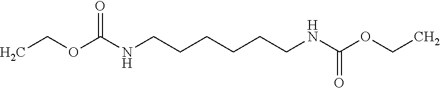 [SMILES: CCOC(=O)NCCCCCCNC(=O)OCC]

In certain preferred oxazolidines of formula (IV) and (V), resp., R⁴ is selected from branched alkyl e.g. sec-C₃-C₁₀-alkyl or tert-C₄-C₁₀, R⁵ is selected from n-C₁-C₁₀-alkyl and R⁶ in formula (V) is methyl.

### Most Preferably, the Oxazolidine is of Formula (VII)

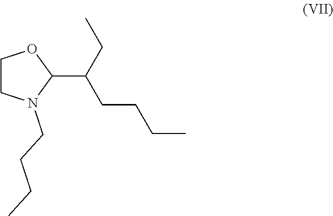 [SMILES: CCCCC(CC)C1OCCN1CCCC]

The oxazolidine of formula (VII) is sold under the trade name “INCOZOL 2” by the company Incorez.

The above-mentioned substances are capable of acting as a drying agent for (i) γ-butyrolactone and (ii) lactones of formula (II)

Prior to the ring-opening co-polymerization, especially before preparing a reaction mixture comprising above-defined reactants (i), (ii), catalyst (iii) and initiator (iv), the dried γ-butyrolactone (I) and the dried lactones of formula (II) may be separated from the drying agent by distillation, in order to avoid the presence of the drying agent resp. its reaction products with water in the target product polyesterol. Especially when CaH₂ is used as the drying agent, it is preferable to separate the dried γ-butyrolactone (I) and the dried lactones of formula (II) from the used-up CaH₂ by means of distillation. Irrespective of the drying agent applied, distillation has to be carried out under protecting atmosphere (e.g. nitrogen or argon), in order to prevent the dried γ-butyrolactone (I) and dried lactones of formula (II) from taking up air moisture.

Preferably, (i) the γ-butyrolactone (I) and (ii) the one or more lactones of formula (II) to be used for the ring opening co-polymerization process according to the invention have a water content of 0.1 wt % or lower, preferably 0.05 wt % or lower, and most preferably 0.01 wt % or lower, as measured by Karl-Fischer-titration. Said low water content may be achieved by applying a drying agent, preferably one of the above-mentioned preferred drying agents.

In certain cases, it is preferred that the above defined process for the synthesis of polyesterols further comprises the step of quenching the ring-opening co-polymerization by adding a quenching solution comprising one or more acids and one or more solvents. By means of quenching, the base (iii) may be neutralized. Without quenching, there is a risk of decomposition of the obtained polyesterol when it is isolated from the reaction mixture at ambient temperature.

In the quenching solution added, the acid or one, more or all of the acids are preferably selected from the group consisting of hydrohalogenic acids, oxo-acids of Cl, S, N, P and B, alkylsulfonic acids, arylsulfonic acids, mono-, di- and tri-functional carboxylic acids. Said mono-, di- and tri-functional carboxylic acids include hydroxy-functionalized mono-, di- and tri-functional carboxylic acids and unsaturated mono-, di- and tri-functional carboxylic acids.

Most preferably, in the quenching solution each acid is selected from the group consisting of hydrohalogenic acids, oxo-acids of Cl, S, N, P and B, alkyl-sulfonic acids, arylsulfonic acids, mono-, di- and tri-functional carboxylic acids as defined above.

Most preferred acids are those selected from the group consisting of hydrochloric acid HCl, perchloric acid HClO₄, nitric acid HNO₃, sulfuric acid H₂SO₄, phosphoric acid H₃PO₄, boric acid B(OH)₃, formic acid, acetic acid, acrylic acid, oxalic acid, propionic acid, lactic acid, citric acid, methanesulfonic acid and toluenesulfonic acid.

The quenching solution comprises one or more solvents. Suitable solvents are those in which the obtained polyesterol is soluble.

In the quenching solution, the solvent or one or more or all of the solvents are preferably selected from the group consisting of aliphatic and aromatic hydrocarbons, ketones, ethers, dialkylcarbonates and dialkylsulfoxides. Most preferably, each solvent in the quenching solution is selected from the group consisting of aliphatic and aromatic hydrocarbons, ketones, ethers, dialkylcarbonates and dialkylsulfoxides.

As used herein, the term “hydrocarbons” is intended to include halogenated hydrocarbons.

Most preferred solvents are those selected from the group consisting of, dichloromethane (DCM), trichloromethane, deuterotrichloromethane (CDCl₃), 1,2-dichlorethane, 1,1,2,2-tetrachlorethane, chlorobenzene, 1,4-dioxane, anisole, dimethylether, acetone, acetophenone, dihydrolevoglucosenon, dimethylcarbonate, diethylcarbonate, dimethylsulfoxide and acetonitrile.

The added quenching solution preferably has a temperature in the range of from −25° C. to 20° C.

In the quenching solution, the total concentration of acids is preferably in the range of from 0.001 mol/l to 1 mol/L preferably in the range from 0.016 mol/L to 0.081 mol/L.

The quenching solution is preferably added in such amount that the concentration of acid provided by the quenching solution corresponds to an amount of 1 to 50 equivalents of acid for 1 equivalent of base, preferably 4 to 20 equivalents of acid for 1 equivalent of base.

Work-up of the reaction mixture and isolation of the produced polyesterol can be affected in any customary manner, for example by means of filtration or aqueous extractive workup, precipitation, distillative removal of the solvent or by means of a combination of some or all of these steps such as first hydrolytic work-up to remove any alkaline base (iii) and alcohol (iv) followed by removal of the organic solvent and any unreacted γ-butyrolactone (I) and unreacted lactones according to formula (II) from the organic phase by evaporation or distillation. The polyesterol is generally obtained in sufficient purity by applying such measures or a combination thereof, rendering additional purification steps unnecessary.

The process according to the invention for the synthesis of polyesterol can be performed continuously, semi-continuously or discontinuously. The reaction can be performed in all reactors known to a person skilled in the art which are suitable for this type of reaction. Suitable reactors are described and reviewed in the relevant literature, e.g. K. Henkel, “Reactor Types and Their Industrial Applications”, Ullmann's Encyclopedia of Industrial Chemistry, 2005, Wiley-VCH Verlag Gmbh & Co. KGaA, chapter 3.3: “Reactors for gas-liquid reactions”.

### An Especially Preferred Process for the Synthesis of Polyesteroles Comprises the Steps of

(A) ring opening co-polymerization of
   (i) γ-butyrolactone (I) and
   (ii) one or both of ε-caprolactone, ε-decalactone and δ-valerolactone in the presence of
   (iii) one or more bases comprising an alkali metal cation selected from the group consisting of lithium tertbutoxide, sodium tertbutoxide, potassium tertbutoxide, di-potassium benzenedimethanol and di-sodium benzenedimethanol, and
   (iv) one or more alcohols selected from the group consisting of 1,4-benzenedimethanol, 1,3,5-benzenetrimethanol, glycerol, trimethylolethane, pentaerythritol, benzyl alcohol, ethyleneglycol, polyethyleneglycol and 1,5-pentanediol,
   at a temperature from −25° C. to +30° C.,
   wherein the molar ratio of the total amount of γ-butyrolactone (I), ε-caprolactone, ε-decalactone and δ-valerolactone to the total amount of bases (iii) comprising an alkali metal cation

((i)+(ii)):(iii)
is 100:1 to 800:1 and
the molar ratio of the total amount of bases (iii) comprising an alkali metal cation to the total amount of OH groups (v) in the alcohols (iv)
(iii):(v)
is in the range of from 1:2 to 8:1. and
wherein the molar ratio of γ-butyrolactone (i) to the total amount of ε-caprolactone and δ-valerolactone (ii) is in a range of from 85:15 to 15:85 and
wherein the ring-opening co-polymerization is carried out in a solvent selected from the group consisting of dichloromethane, toluene, 2-methyl-tetrahydrofurane, 1,4-dioxane, glyme, diglyme, ethyl acetate, dimethylformamide, dimethylsulfoxide and acetonitrile and mixtures thereof, and
wherein γ-butyrolactone (I), ε-caprolactone, ε-decalactone and δ-valerolactone have a water content of 0.01 wt % or lower, as measured by Karl-Fischer-titration, and
(B) quenching the ring-opening co-polymerization by adding a quenching solution comprising an acid and a solvent, wherein
   said acid is selected from the group consisting of hydrochloric acid, perchloric acid, nitric acid, sulfuric acid, phosphoric acid, boric acid, formic acid, acetic acid, acrylic acid, oxalic acid, propionic acid, lactic acid, citric acid, methanesulfonic acid and toluenesulfonic acid
   said solvent is selected from the group consisting of dichloromethane, trichloromethane, deuterotrichloromethane, 1,2-dichlorethane, 1,1,2,2-tetrachlorethane, chlorobenzene, 1,4-dioxane, anisole, dimethylether, acetone, acetophenone, dihydrolevoglucosenon, dimethylcarbonate, diethylcarbonate, dimethylsulfoxide, acetonitrile and mixtures thereof,
   said quenching solution has a temperature in the range of −25° C. to +50° C.
      In a Further Aspect, there is Disclosed the Use of a Kit Comprising
(iii) one or more bases comprising an alkaline metal cation
(iv) one or more alcohols
   in a process for the synthesis of polyesterols as defined above.

Specific and preferred bases (iii) comprising an alkaline metal cation are as mentioned above. Specific and preferred alcohols (iv) are as mentioned above. Specific and preferred combinations of bases (iii) comprising an alkaline metal cation and alcohols (iv) are as mentioned above. Preferably, the kit is used in one of the above-defined specific and preferred processes for the synthesis of a polyesterol.

In a further aspect, there is disclosed a polyesterol obtainable by the above-defined process. Preferably, the polyesterol is obtainable by one of the above-defined specific and preferred processes.

Polyesterols obtainable by the above-defined process contain building units derived from (i) γ-butyrolactone (I) and building units derived from (ii) one or more lactones according to formula (II). Preferred are polyesterols containing building units derived from (i) γ-butyrolactone (I) and building units derived from (ii) the one or more lactones selected from the group consisting of ε-caprolactone, ε-decalactone, δ-valerolactone, β-propiolactone, lactide and glycolide. In certain cases, preferred polyesterols contain building units derived from (i) γ-butyrolactone (I) and building units derived from (ii) one lactone selected from the group consisting of ε-caprolactone, ε-decalactone, δ-valerolactone, β-propiolactone, lactide and glycolide. Most preferred are polyesterols containing building units derived from (i) γ-butyrolactone (I) and building units derived from (ii) one lactone selected from the group consisting of ε-caprolactone, ε-decalactone, and δ-valerolactone.

Preferably, one, more or all of the lactones according to formula (II) are selected from the group consisting of ε-caprolactone, ε-decalactone, δ-valerolactone, β-propiolactone, lactide and glycolide.

Preferred are polyesterols obtainable by the above-defined process wherein the fraction of building units derived from (i) γ-butyrolactone (I) is of 20 mol % or more, preferably of 30 mol % or more, more preferably of 40 mol % or more.

Polyesterols obtainable by the above-defined process preferably have one or more of the following properties
a number-average molecular weight (Mₙ) determined by gel permeation chromatography (GPC) in the range of from 1,000 g/mol to 20,000 g/mol
a weight-average molecular weight (M_{w}) determined by gel permeation chromatography (GPC) in the range of from 1,500 g/mol to 40,000 g/mol
a molecular weight distribution (Ð) (M_{w}/Mₙ) determined by gel permeation chromatography (GPC) in the range of from 1.3 to 5.0
a decomposition onset temperature (T5%) determined by thermogravimetric analysis (TGA) in the range of from 220° C. to 250° C.
a glass transition temperature (Tg) determined by differential scanning calorimetry in the range of from −70° C. to +80° C.
a crystallization temperature (Tc) determined by differential scanning calorimetry in the range of from −30° C. to +35° C.
a melting temperature (Tm) determined by differential scanning calorimetry in the range of from −20° C. to 120° C.

Methods for determining the above-mentioned parameters are known in the art. For details, see the examples section.

Preferred polyesterols obtainable by the above-defined process are soluble in one or more solvents selected from the group consisting of tetrahydrofurane, 2-methyl tetrahydrofurane, acetone, acetonitrile, dichloromethane, dimethyl sulfoxide (DMSO), chlorobenzene, chloroform, 1,2-dichloroethane, 1,1,2,2-tetrachloroethane, dimethyl formamide, ethyl acetate, γ-butyrolactone (GBL), dimethyl carbonate, diethyl carbonate, dimethoxyethane (=glyme), dihydrolevoglucosenon (cyrene), and toluene.

Application fields of polyesterols obtainable by the above-defined process include, for example, adhesives, e.g. hotmelt adhesives or compostable adhesives, and encapsulation of crop protection products.

The polyesterols obtainable by the above-defined process can be used in seed treatment compositions and methods of treating seed. Thus, the present invention also relates to the use of these polymers in seed treatment compositions. Seed treatment is the process of applying active ingredients to seeds in order to support the germination and/or the growth. Seed treatment is applicable to a large variety of crops. Typical examples include the application of pesticides such as fungicides, insecticides and plant growth regulators, as well as other active ingredients such as fertilizers.

Polyesteroles obtainable by the above-defined process can be used in the form of a blend with one or more other polymers, this way increasing the content of renewables in the final part.

Besides these applications, polyesteroles obtainable by the above-defined process can be used as intermediate for the preparation of other polymers or elastomers, e.g. for homecare or cosmetic applications or for technical polymers such as polyurethanes.

Especially, Polyesterols Obtainable by the Above-Defined Process which are Polyols can be Used for the Preparation of
thermoplastic polyurethanes, e.g. for extrusion applications, preferably for an extruded article, more preferably an extruded article selected from the group consisting of cable jacketing, tube and hose, for injection molding applications, preferably for an injection molded article, more preferably for an injection molded article selected from the group consisting of roller, gasket, seal, railway pad, and conveyor belt, preferably with improved compression set, with improved thermal resistance and creep performance,
polyurethane foams
cast elastomers
thermoplastic copolyesters and further specialty polymers.

### Polyesterols Obtainable by the Above-Defined Process can Also be Used as Binder in Coating Applications Such as

conventional base coats,
water based coats,
liquid base coats, which are essentially solvent- and water-free (so called 100% systems),
solid water-free base coats such as powder coatings and pigmented powder coatings,
solvent-free, possibly pigmented powder coating dispersions such as powder slurry base coats.

Such coatings can be hardened by thermal treatment, by radiation, or by a dual cure hardening process. They are self-crosslinking or are crosslinked by external crosslinking agents.

These coatings are suitable for coating substrates like wood, paper, textiles, leather, nonwovens, plastics, glass, ceramics, mineral products, e.g. for construction, such as cement stones or fiber-cement boards, and especially metals or coated metals.

The coating process is performed according to processes known in the art, whereby at least a coating containing one or more polyesterols obtainable by the above-defined process is applied on a substrate in the desired thickness, and then volatile components are removed. This process can be repeated once or multiple times if desired. Application of the coating on a substrate can be done according to known processes such as spraying, stopping, coating with a doctor knife, brushing, rolling, or casting. The strength of such coating is typically from 3 to 1000 g/m² and preferably 10 to 200 g/m².

Polyesterols obtainable by the above-defined process can also be used in the production of printing inks or printed coatings, being used as additives such as dispersing aids, stabilizers, or bonding agents. A preferred application is the use as binder for printing inks or printed coatings.

Furthermore, polyesterols obtainable by the above-defined process can be used in cosmetic and dermatological formulations as rheology modifiers, especially as thickeners, especially as oil thickening polymers suitable for cosmetic applications.

### EXAMPLES

The following examples are meant to further explain and illustrate the present invention without limiting its scope.

The conversion (Conv.) of the lactones as given in the following tables also represents their percentage incorporated in the copolymer.

### Preparation of Poly(GBL-Co-DVL) Table 1, Example 1

The ring-opening co-polymerization of γ-butyrolactone (GBL) and δ-valerolactone (DVL) was performed in a flame-dried 100 mL round bottom flask. In an Argon filled glovebox, the round bottom flask was charged with GBL (10 mL, 130 mmol, 0.66 eq) and DVL (6 mL, 65 mmol, 0.33 eq) and sealed with a septum. A separate 5 mL vial was charged with the base potassium tert-butoxide (110.5 mg, 0.985 mmol, 0.005 eq) followed by the solvent 2-MeTHF (4 mL, resulting in a concentration of GBL+DVL of 50 M in the reaction mixture to be formed) and the initiator 1,4-benzenedimethanol (272.2 mg, 1.97 mmol, 0.01 eq), and the vial was sealed. The round bottom flask and the vial were taken out of the glovebox. The premix of base, initiator and solvent was sonicated 10 min until a homogeneous suspension was obtained. The round bottom flask was immersed in the cooling bath at −21° C. After 40 min equilibration at said temperature, a reaction mixture was formed and the ring-opening co-polymerization of GBL and DVL was initiated by addition of the premix base/initiator/solvent via a gastight syringe at once. After 45 minutes at −21° C., the co-polymerization was quenched by addition of 40 mL of a cold (−21° C.) solution of acetic acid in DCM (5 μL/mL), and the obtained product was immediately well homogenized with a spatula until the precipitated polymer was redissolved. The volatile constituents of the quenched reaction mixture were evaporated using a rotative evaporator (at 35° C. until 20 mbar was reached). The remaining viscous liquid was precipitated using cold methanol:water, 9:1, filtered, washed with cold methanol:water, 9:1 and dried under high vacuum (0.1 mbar) for 24 hours.

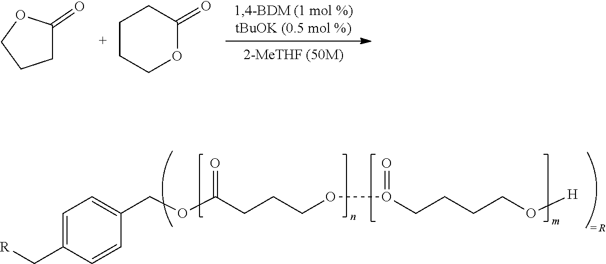

TABLE 1
(Example 1)

| | | Molar | mmol | | | | | | | |
|---|---|---|---|---|---|---|---|---|---|---|
| | | ratio | ratio | | | | | CP | | |
| Initiator (I)/ | molar ratio | GBL/ | GBL/ | Time | T | Conv. | Conv. | GBL/ | isolated | Mₙ |
| Base (B) | M^{[a]}/I/B | DVL | DVL | (min) | (° C.) | DVL^{[b]} | GBL^{[b]} | DVL^{[b]} | yield | (g/mol)^{[c]} |
| 1,4-BDM/ | 100:1:0.5 | 66:33 | 130:65 | 45 | −21 | >99% | 45.6% | 41:59 | 65% | 8473 |
| tBuOK | | | | | | | | | | |

### 1,4-BDM=1,4-benzenedimethanol

CP=Composition of the obtained copolymer (mol GBL: mol DVL)
[a] M=GBL+DVL
[b] Determined by ¹H NMR.
[c] Determined by ¹H-NMR of the pure copolymer by comparing the integration value of the signal from the initiator, 1,4-BDM [5.09 ppm] as A, with the CH₂ signal from poly-γ-butyrolactone [1.95 ppm] as B, the 2 CH₂ signal from poly-δ-valerolactone [1.67 ppm] as C; the protons are written N_{A}, N_{B} and N_{c} corresponding to the number of proton integrated for the initiator A, the pGBL B and the pDVL C; and Not represent the number of —OH in the initiator (N_{OH}(diols)=2). Mₙ was calculated the following equation:

$${M}_{n} \{ poly - B - co - C \} = [ ( \frac{B / Nb}{A / Na} \times {M}_{w} ( B ) ) + ( \frac{C / Nc}{A / Na} \times {M}_{w} ( C ) ) ] \times {N}_{OH} + {M}_{w} ( A )$$

Application of the polyesterol according to Example 1 in polyurethane foam formation

A polyurethane foam was obtained by reacting the polyol obtained in example 1 with 4,4′-diisocyanato dicyclohexylmethane (H12MDI, IUPAC name 1-isocyanato-4-[(4-isocyanatocyclohexyl)methyl]cyclohexane) as diisocyanate according to the following reaction equation:

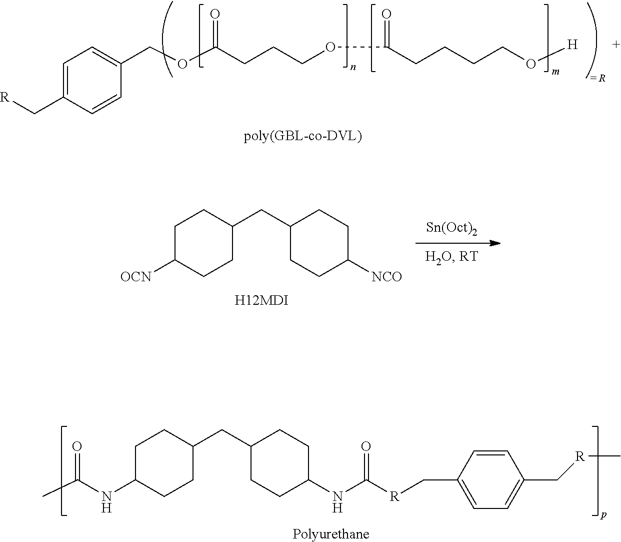

Water was used as the foaming agent.

TABLE 2

| | | | | H₂O | |
|---|---|---|---|---|---|
| | | | | as | |
| | H12MDI | Sn(Oct)₂ | | foaming | |
| | (μL) | (μL) | Polyol | agent | |
| Test # | [1.0 eq] | [mol %] | (mg) | (μL) | Observation |
| 1 | 300 | 15 [4] | 200 | 100 | slight foaming |
| 2 | 100 | 15 [12] | 500 | 30 | dense foaming, |
| | | | | | small bubble |
| 4 | 150 | 15 [8] | 500 | 50 | foaming, medium |
| | | | | | bubble |
| 3 | 250 | 15 [5] | 500 | 80 | good foaming, some |
| | | | | | large bubble |
| 5 | 250 | 30 [10] | 500 | — | foaming, large |
| | | | | | bubble |
| 6 | 250 | 30 [10] | 500 | 40 | large foaming, |
| | | | | | large bubble |
| 7 | 500 | 30 [5] | 500 | 100 | foaming, large & |
| | | | | | small bubble |

These experiments show that the polyesterol according to Example 1 may be used as polyols in the synthesis of polyurethane foams.

### Preparation of Poly(GBL-Co-DVL) Table 3, Examples 2 to 28

The ring-opening co-polymerization of γ-butyrolactone (GBL) and δ-valerolactone (DVL) was performed in a sealed 10 mL vial. In an argon filled glovebox, the 10 mL vial was charged with both monomers GBL (8 mmol to 13 mmol, 0.4 eq to 0.66 eq) and DVL (6.5 mmol to 12 mmol, 0.33 eq to 0.6 eq) and sealed with a septum. A separate 1 mL vial was charged with the base potassium tert-butoxide (0.0025 eq to 0.02 eq) followed by the solvent 2-MeTHF (400 μL, resulting in a concentration of GBL+DVL of 50 M in the reaction mixture to be formed) and the initiator 1,4-benzenedimethanol (0.01 eq), and the vial was sealed. The vials were taken out of the glovebox. The premix base/initiator/solvent was sonicated 5 min until a homogeneous suspension was obtained. The vial containing GBL and DVL was immersed in the cooling bath at the temperature indicated in table 3 (from −21 to +25). After 30 min equilibration at said temperature, a reaction mixture was formed and the ring-opening co-polymerization of GBL and DVL was initiated by addition of the premix base/initiator/solvent via a gastight syringe at once. After the time indicated in Table 3, the co-polymerization was quenched by addition of 4 mL (at the temperature indicated in Table 3) of acetic acid in CDCl₃ (5 μL/mL) solution, and the obtained product was immediately well homogenized with a spatula until the precipitated polymer was redissolved. The quenched reaction mixture was analyzed by ¹H-NMR to obtain the percentage of converted monomer and yield.

TABLE 3

| | Mol Ratio | molar ratio | mmol ratio | Time | T | Conv. | Conv. | Total |
|---|---|---|---|---|---|---|---|---|
| Example | M^{[a]}/I/B | GBL/DVL | GBL/DVL | (min) | (° C.) | DVL^{[b]} | GBL^{[b]} | conv. |
| 2 | 100:1:2 | 66:33 | 13:6.5 | 240 | −21 | 80.1% | 19.9% | 40.0% |
| 3 | 100:1:1 | 66:33 | 13:6.5 | 240 | −21 | 53.7% | 10.4% | 24.8% |
| 4 | 100:1:1.5 | 66:33 | 13:6.5 | 240 | −21 | 90.2% | 19.7% | 43.2% |
| 5 | 100:1:1 | 66:33 | 13:6.5 | 240 | −21 | 45.1% | 12.9% | 23.6% |
| 6 | 100:1:0.5 | 66:33 | 13:6.5 | 240 | −21 | >99% | 35.7% | 57.6% |
| 7 | 100:1:0.25 | 66:33 | 13:6.5 | 240 | −21 | 62% | 10% | 27% |
| 8 | 100:1:0.5 | 66:33 | 13:6.5 | 25 | −21 | 85.4% | 26.7% | 46.2% |
| 9 | 100:1:0.5 | 66:33 | 13:6.5 | 35 | −21 | >99% | 34.4% | 56.7% |
| 10 | 100:1:0.5 | 66:33 | 13:6.5 | 45 | −21 | >99% | 42.3% | 63.3% |
| 11 | 100:1:0.5 | 66:33 | 13:6.5 | 60 | −21 | >99% | 42.8% | 64.2% |
| 12 | 100:1:0.5 | 66:33 | 13:6.5 | 18 h | −21 | >99% | 46.1% | 66.6% |
| 13 | 100:1:0.5 | 66:33 | 13:6.5 | 45 | −10 | >99% | 41.0% | 60.7% |
| 14 | 100:1:0.5 | 66:33 | 13:6.5 | 45 | 0 | >99% | 37.5% | 58.4% |
| 15 | 100:1:0.5 | 66:33 | 13:6.5 | 45 | 25 | >99% | 21.1% | 47.4% |
| 16 | 100:1:0.5 | 50:50 | 10:10 | 45 | 25 | >99% | 19.5% | 59.8% |
| 17 | 100:1:0.5 | 50:50 | 10:10 | 45 | −10 | >99% | 44.9% | 72.4% |
| 18 | 100:1:0.5 | 40:60 | 8:12 | 45 | −10 | >99% | 34.9% | 73.9% |
| 19 | 100:1:0.5 | 50:50 | 10:10 | 1 | −10 | >99% | 28.4% | 65.2% |
| 20 | 100:1:0.5 | 50:50 | 10:10 | 3 | −10 | >99% | 31.0% | 67.0% |
| 21 | 100:1:0.5 | 50:50 | 10:10 | 5 | −10 | >99% | 35.1% | 68.1% |
| 22 | 100:1:0.5 | 50:50 | 10:10 | 7 | −10 | >99% | 37.8% | 70.7% |
| 23 | 100:1:0.5 | 50:50 | 10:10 | 9 | −10 | >99% | 40.2% | 71.3% |
| 24 | 100:1:0.5 | 50:50 | 10:10 | 10 | −10 | >99% | 42.1% | 71.1% |
| 25 | 100:1:0.5 | 50:50 | 10:10 | 20 | −10 | >99% | 44.0% | 72.0% |
| 26 | 100:1:0.5 | 50:50 | 10:10 | 30 | −10 | >99% | 44.4% | 72.2% |
| 27 | 100:1:0.5 | 50:50 | 10:10 | 38 | −10 | >99% | 42.0% | 71.0% |
| 28 | 100:1:0.5 | 50:50 | 10:10 | 120 | −10 | >99% | 44.3% | 72.1% |

^{[a]}M = GBL + DVL
^{[b]}Determined by ¹H NMR.

### Preparation of Poly(GBL-Co-DVL) Table 4, Examples 29 to 33

The ring-opening co-polymerization of γ-butyrolactone (GBL) and δ-valerolactone (DVL) was performed in a sealed 10 mL vial. In an Argon filled glovebox, the 10 mL vial was charged with both monomers GBL (10 mmol, 0.5 eq), DVL (10 mmol, 0.5 eq) and sealed with a septum. A separate 1 mL vial was charged with the base potassium tert-butoxide (0.0025 eq to 0.01 eq) followed by the solvent 2-MeTHF (400 μL, resulting in a concentration of GBL+DVL of 50 M in the reaction mixture to be formed) and the initiator indicated in Table 4 (0.01 eq) and sealed. The vials were taken out of the glovebox. The premix base/initiator/solvent was sonicated 5 min until a homogeneous suspension was obtained. The vial containing the GBL and DVL was immersed in the cooling bath at −10° C. After 30 min equilibration at said temperature, the ring-opening copolymerization of GBL and DVL was initiated by addition of the premix base/initiator/solvent via a gastight syringe at once. After 45 minutes, a reaction mixture was formed and the co-polymerization was quenched by addition of 4 mL (at −10° C.) of acetic acid in CDCl₃ (5 μL/mL) solution, and the product was immediately well homogenized with a spatula until the precipitated polymer was redissolved. The quenched reaction mixture was analyzed by ¹H-NMR to obtain the percentage of converted monomer and yield.

TABLE 4

| | | Mol Ratio | Conv. | Conv. | Total |
|---|---|---|---|---|---|
| Example | Initiator (I)/Base (B) | M^{[a]}/I/B | DVL^{[b]} | GBL^{[b]} | conv. |
| 29 | 1,3,5-BTM/tBuOK | 100:1:0.75 | 94% | 33% | 64% |
| 30 | Gly/tBuOK | 100:1:0.75 | 84% | 26% | 55% |
| 31 | TMOE/tBuOK | 100:1:0.75 | 88% | 26% | 57% |
| 32 | PETP/tBuOK | 100:1:1 | 97% | 33% | 64% |
| 33 | BnOH/tBuOK | 100:1:0.25 | 84% | 22% | 53% |

1,3,5-BTM: 1,3,5-benzenetrimethanol; Gly: glycerol; TMOE: trimethylolethane; PETP: pentaerythritol; BnOH: benzyl alcohol.
^{[a]}M = GBL + DVL
^{[b]}Determined by ¹H NMR.

### Preparation of Poly(GBL-Co-DVL) Table 5, Example 34

The ring-opening co-polymerization of γ-butyrolactone (GBL) and δ-valerolactone (DVL) was performed in a flame-dried 100 mL round bottom flask. In an Argon filled glovebox, the round bottom flask was charged with GBL (100 mmol, 0.5 eq) and DVL (100 mmol, 0.5 eq) and sealed with a septum. A separate 5 mL vial was charged with the base potassium tertbutoxide (2 mmol, 0.01 eq) followed by the solvent 2-MeTHF (4 mL, resulting in a concentration of GBL+DVL of 50 M in the reaction mixture to be formed) and the initiator pentaerythritol (2 mmol, 0.01 eq), and the vial was sealed. The round bottom flask and the vial were taken out of the glovebox. The premix base/initiator/solvent was sonicated 10 min until a homogeneous suspension was obtained. The round bottom flask was immersed in the cooling bath at −10° C. After 40 min equilibration at said temperature, a reaction mixture was formed and the ring-opening co-polymerization of GBL and DVL was initiated by addition of the premix base/initiator/solvent via a gastight syringe at once. After 45 minutes at −10° C., the co-polymerization was quenched by addition of 40 mL of a cold (−10° C.) solution of acetic acid in DCM (5 μL/mL), and the obtained product was immediately well homogenized with a spatula until the precipitated polymer was redissolved. The volatile constituents of the quenched reaction mixture were evaporated using a rotative evaporator (at 35° C. until 20 mbar was reached). The remaining viscous liquid was precipitated using cold methanol:water, 9:1, filtered, washed with cold methanol:water, 9:1 and dried under high vacuum (0.1 mbar) for 24 hours.

TABLE 5

| | Initiator (I)/ | Mol Ratio | Conv. | Conv. | CP | Isolated |
|---|---|---|---|---|---|---|
| Example | Base (B) | M^{[a]}/I/B | DVL^{[b]} | GBL^{[b]} | GBL/DVL^{[b]} | yield |
| 34 | PETP/tBuOK | 100:1:1 | >99% | 25% | 20:80 | 62% |

PETP: pentaerythritol;
CP = Composition of the obtained copolymer (mol GBL · mol DVL).
^{[a]}M = GBL + DVL
^{[b]}Determined by ¹H NMR.

### Preparation of Poly(GBL-Co-DVL) Table 6 and 7, Examples 35 to 38

The ring-opening co-polymerization was performed under N₂ atmosphere in a 50 ml Schlenk tube which was previously dried in an oven at 120° C. overnight. After performing 3 cycles of high vacuum/N₂ the dried Schlenk tube was sealed and charged with GBL (0.33 eq to 0.91 eq) and DVL (0.09 eq to 0.67 eq). The water scavenger (drying agent) Incozol 2 (0.002 eq) was added to the GBL/DVL mixture via a gastight syringe and stirred for 1 h at room temperature under N₂ atmosphere. The sealed Schlenk tube was then immersed in a cooling bath at −10° C. during 30 min for temperature equilibration. A separate vial was dried in the oven at 120° C. and the air was evacuated by 3 cycles of high vacuum/N₂ before sealing. It was then charged with anhydrous 2-MeTHF (resulting in a concentration of GBL+DVL of 100 M in the reaction mixture to be formed), the base anhydrous solution of potassium tert-butoxide in 2-MeTHF (2 M, 25 wt %, 0.005) and the initiator benzyl alcohol (0.01 eq) via a gastight syringe. The mixture base/initiator/solvent was sonicated 10 min until a homogeneous suspension was obtained. A reaction mixture was formed and the ring-opening co-polymerization of GBL and DVL was initiated by addition of the premix Base/Initiator/Solvent via a gastight syringe at once.

After 4 h, the ring-opening co-polymerization was quenched by addition of 40 mL of a cold (−10° C.) solution of acetic acid in DCM (5 μL/mL) before gently crushing the white solid polymer formed with a spatula. The quenched mixture was then allowed to warm to room temperature. It was then washed with distilled water (3×50 mL) in a separating funnel and then the volatiles were evaporated on rotative evaporator (40° C., until 20 mbar was reached). The remaining viscous liquid was precipitated using cold methanol (0° C.). In the case where the obtained precipitate was a viscous liquid, it was washed several times with methanol by successive centrifugation/redispersions (4000 rpm, 2 min, 10° C.) and isolated by centrifugation before drying under reduced pressure. In the case where the obtained precipitate is a solid, it was filtered, washed with cold methanol and dried under vacuum on rotative evaporator to afford the corresponding copolymer.

TABLE 6

| | Ratio | Conv. | Conv. | CP | Isolated | |
|---|---|---|---|---|---|---|
| Example | GBL/DVL | GBL^{[a]} | DVL^{[a]} | GBL/DVL^{[a]} | yield | Comment |
| 35 | 91/9 | 37% | 95% | 78/22 | 45% | Viscous/pink |
| 36 | 67/33 | 49% | 99% | 49/51 | 77% | viscous transparent liquid |
| 37 | 50/50 | 41% | 93% | 30/70 | 70% | White wax |
| 38 | 33/67 | 30% | 66% | 19/81 | 15% | White wax |

CP = Composition of the obtained copolymer (mol GBL:mol DVL)
^{[a]}Determined by 1H-NMR

The Copolymers Obtained in Examples 35-38 have the Following Properties:

TABLE 7

| Example | Mₙ (g/mol) | M_{w} (g/mol) | Ð | T_{g} (° C.) | T_{c} (° C.) | Tₘ (° C.) |
|---|---|---|---|---|---|---|
| 35 | 8701 | 14996 | 1.72 | −56.8 | — | 28 |
| 36 | 2274 | 10838 | 4.77 | −59.5 | — | 14.6 |
| 37 | 9205 | 14653 | 1.59 | −56.6 | −6.9 | 26 |
| 38 | 11826 | 15787 | 1.33 | −58.7 | 7.3 | 36.1 |

Mₙ, M_{w} and Ð (M_{w}/Mₙ) were determined from GPC in THF.
Glass transition temperature (T_{g}), crystallization temperature (T_{c}) and melting temperature (Tₘ) were measured by DSC

### Preparation of Poly(GBL-Co-DVL) Table 8 and 9, Examples 39 to 44

The ring-opening copolymerization was performed under N₂ atmosphere in a 50 ml Schlenk tube which was previously dried in an oven at 120° C. overnight. After performing 3 cycles of high vacuum/N₂ the dried Schlenk tube was sealed and charged with GBL (0.67 eq to 0.83 eq) and DVL (0.17 eq to 0.33 eq). The water scavenger (drying agent) Incozol 2 (0.002 eq) was added to the GBL/DVL mixture via a gastight syringe and stirred for 1 h at room temperature under N₂ atmosphere. The sealed Schlenk tube was then immersed in a cooling bath at −10° C. during 30 min for temperature equilibration.

A separate vial was dried in the oven at 120° C. and the air was evacuated by 3 cycles of high vacuum/N₂ before sealing. It was then charged with anhydrous 2-MeTHF (resulting in a concentration of GBL+DVL of 100 M in the reaction mixture to be formed), the base anhydrous solution of potassium tert-butoxide in 2-MeTHF (2 M, 25 wt %, 0.01 eq to 0.02 eq) and the initiator indicated in Table 8 (0.01 eq) via a gastight syringe. The premix base/initiator/solvent was sonicated 10 min until a homogeneous suspension was obtained. A reaction mixture was formed and the ring-opening copolymerization of GBL and DVL was initiated by addition of the premix base/initiator/solvent via a gastight syringe at once.

After 4 h, the co-polymerization was quenched by addition of 40 mL a cold (−10° C.) solution of acetic acid in DCM (5 μL/mL) before gently crushing the white solid polymer formed with a spatula. The quenched mixture was then allowed to warm to room temperature. It was then washed with distilled water (3×50 mL) in a separating funnel and then the volatiles were evaporated on rotative evaporator (40° C., until 20 mbar was reached). The remaining viscous liquid was precipitated using cold methanol (0° C.). In the case where the obtained precipitate was a viscous liquid, it was washed several times with methanol by successive centrifugation/redispersions (4000 rpm, 2 min, 10° C.) and isolated by centrifugation before drying under reduced pressure. In the case where the obtained precipitate is a solid, it was filtered, washed with cold methanol and dried under vacuum on rotative evaporator to afford the corresponding copolymer.

TABLE 8

| | | | | Conversion | CP | Isolated | |
|---|---|---|---|---|---|---|---|
| | Ratio | Initiator | Mol Ratio | GBL/DVL | GBL/ | yield | |
| Example | GBL/DVL | (I) | M^{[a]}/I/B | (%)^{[b]} | DVL^{[b]} | (%) | Comment |
| 39 | 67/33 | 1,5-PDO | 100/1.0/1.0 | 7/69 | 22/78 | 19 | White solid |
| 40 | 67/33 | PEG 400 | 100/1.0/1.0 | 14/99 | 24/76 | 28 | White wax |
| 41 | 83/17 | PEG 400 | 100/1.0/1.0 | 14/97 | 38/62 | 14 | Very viscous |
| | | | | | | | transparent |
| | | | | | | | liquid |
| 42 | 67/33 | 1,4-BDM | 100/1.0/2.0 | 36/96 | 43/57 | 50 | Viscous pink |
| | | | | | | | liquid |
| 43 | 75/25 | EG | 100/1.0/2.0 | 32/93 | 51/49 | 28 | Viscous pink |
| | | | | | | | liquid |
| 44 | 67/33 | EG | 100/1.0/2.0 | 43/94 | 47/53 | 45 | Viscous pink |
| | | | | | | | liquid |

CP = Composition of the obtained copolymer (mol GBL:mol DVL)
1,5P-PDO: 1,5-pentanediol;
PEG400: polyethyleneglycol 400;
1,4-BDM: 1,4-benzenedimethanol;
EG: ethyleneglycol
^{[a]}M = GBL + DVL
^{[b]}Determined by 1H-NMR

The Copolymers Obtained in Examples 42-44 have the Following Properties:

TABLE 9

| example | GBL/DVL (%) | Mₙ (g/mol) | M_{w} (g/mol) | Ð | T_{g} (° C.) | T_{c} (° C.) | Tₘ (° C.) |
|---|---|---|---|---|---|---|---|
| 42 | 43/57 | 12 834 | 17 387 | 1.35 | −62.1 | −19.0 | 9.8 |
| 43 | 51/49 | 9 613 | 11 754 | 1.22 | −56.0 | — | 15.7 |
| 44 | 47/53 | 9 137 | 10 615 | 1.16 | −56.5 | −27.3 | 13.9 |

Mₙ, M_{w} and Ð (M_{w}/Mₙ) were determined from GPC in THF.
Glass transition temperature (T_{g}), crystallization temperature (T_{c}) and melting temperature (Tₘ) were measured by DSC

### Preparation of Poly(GBL-Co-ECL) Table 10, Example 45

The ring-opening-copolymerization of γ-butyrolactone (GBL) and ε-caprolactone (ECL) was performed in a sealed 10 mL vial. In an Argon filled glovebox, the 10 mL vial was charged with both monomers GBL (10 mmol, 0.5 eq), and ECL (10 mmol, 0.5 eq) and was sealed with a septum. A separate 1 mL vial was charged with the base potassium tertbutoxide (0.005 eq) followed by the solvent 2-MeTHF (400 μL, resulting in a concentration of GBL+ECL of 50 M in the reaction mixture to be formed) and the initiator 1,4-benzenedimethanol (0.01 eq), and the vial was sealed. The vials were taken out of the glovebox. The premix base/initiator/solvent was sonicated 5 min until a homogeneous suspension was obtained. The vial containing the GBL and ECL was immersed in the cooling bath at −10° C. After 30 min equilibration a reaction mixture was formed and the ring-opening copolymerization of GBL and ECL was initiated by addition of the premix base/initiator/solvent via a gastight syringe at once. After 45 minutes, the co-polymerization was quenched by addition of 4 mL (at the temperature indicated in Table 10) of acetic acid in CDCl₃ (5 μL/mL) solution, and the obtained product was immediately well homogenized with a spatula until the precipitated polymer was redissolved. The quenched reaction mixture was analyzed by ¹H-NMR to obtain the percentage of converted monomer and yield.

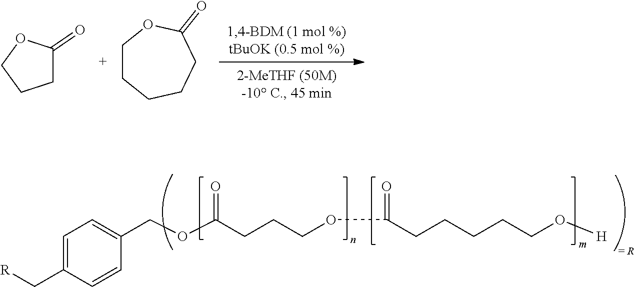

TABLE 10
(Example 45)

| Initiator (I)/ | Mol Ratio | Molar ratio | mmol ratio | Time | T | Conv. | Conv. | Total |
|---|---|---|---|---|---|---|---|---|
| Base (B) | M^{[a]}/I/B | GBL/ECL | GBL/ECL | (min) | (° C.) | ECL^{[b]} | GBL^{[b]} | Conv. |
| 1,4-BDM/ | 100:1:0.5 | 50:50 | 10:10 | 45 | −10 | >99% | 55% | 78% |
| tBuOK | | | | | | | | |

^{[a]}M = GBL + ECL
^{[b]}Determined by ¹H NMR.

### Preparation of Poly(GBL-Co-ECL) Table 11, Example 46 to 47

The ring-opening copolymerization of γ-butyrolactone (GBL) and ε-caprolactone (ECL) was performed in a flame-dried 100 mL round bottom flask. In an Argon filled glovebox, the round bottom flask was charged with GBL (100 mmol, 0.5 eq), ECL (100 mmol, 0.5 eq) and sealed with a septum. A separate 5 mL vial was charged with the base potassium tertbutoxide (1 mmol, 0.005 eq) followed by the solvent 2-MeTHF (4 mL, resulting in a concentration of GBL+ECL of 50 M in the reaction mixture to be formed) and the initiator indicated in Table 11 (2 mmol, 0.01 eq), and the vial was sealed. The round bottom flask and the vial were taken out of the glovebox. The premix base/initiator/solvent was sonicated 10 min until a homogeneous suspension was obtained. The round bottom flask was immersed in the cooling bath at −10° C. After 40 min equilibration at said temperature a reaction mixture was formed and the ring-opening co-polymerization of GBL and ECL was initiated by addition of the premix base/initiator/solvent via a gastight syringe at once. After 45 minutes at −10° C., the co-polymerization was quenched by addition of 40 mL of a cold (−10° C.) solution of acetic acid in DCM (5 μL/mL), and the obtained product was immediately well homogenized with a spatula until the precipitated polymer was redissolved. The volatile constituents of the quenched reaction mixture were evaporated using a rotative evaporator (at 35° C. until 20 mbar was reached). The remaining viscous liquid was precipitated using cold methanol:water, 9:1, filtered, washed with cold methanol:water, 9:1 and dried under high vacuum (0.1 mbar) for 24 hours.

TABLE 11

| | | | molar | mmol | | | | | CP | | |
|---|---|---|---|---|---|---|---|---|---|---|---|
| | Initiator (I)/ | Mol Ratio | ratio | ratio | Time | T | Conv. | Conv. | GBL/ | Isolated | Mₙ |
| Example | Base (B) | M^{[a]}/I/B | GBL/ECL | GBL/ECL | (min) | (° C.) | ECL^{[b]} | GBL^{[b]} | ECL^{[b]} | Yield | (g/mol)^{[c]} |
| 46 | 1,4-BDM/ | 100:1:0.5 | 50:50 | 100:100 | 45 | −10 | >99% | 43% | 30:70 | 70% | 15020 |
| | tBuOK | | | | | | | | | | |
| 47 | 1,4-BDO/ | 100:1:0.5 | 50:50 | 100:100 | 45 | −10 | >99% | 30% | 23:77 | 65% | — |
| | tBuOK | | | | | | | | | | |

1,4-BDO = 1,4-butanediol;
CP = Composition of the obtained co-polymer (mol GBL:mol ECL)
^{[a]}M = GBL + ECL
^{[b]}Determined by ¹H NMR.
^{[c]}Determined by ¹H-NMR of the pure copolymer by comparing the integration value of the signal from the initiator, 1,4-BDM [5.09 ppm] as A, with the CH₂ signal from poly-γ-butyrolactone [1.95 ppm] as B, the 2 CH₂ signal from poly-ε-caprolactone [1.66 ppm] as C; the protons are written N_{A}, N_{B} and N_{C} corresponding to the number of proton integrated for the initiator A, the pGBL B and the pECL C; and N_{OH} represent the number of —OH in the initiator (N_{OH}(diols) = 2). Mₙ was calculated the following equation:

$${M}_{n} \{ poly - B - co - C \} = [ ( \frac{B / Nb}{A / Na} \times {M}_{w} ( B ) ) + ( \frac{C / Nc}{A / Na} \times {M}_{w} ( C ) ) ] \times {N}_{OH} + {M}_{w} ( A )$$

### Preparation of Poly(GBL-Co-ECL) Table 12 and 13, Examples 48 to 50

The ring-opening co-polymerizations was performed under N₂ atmosphere in a 50 ml Schlenk tube which was previously dried in an oven at 120° C. overnight. After performing 3 cycles of high vacuum/N₂ the dried Schlenk tube was sealed and charged with GBL (0.67 eq to 0.83 eq) and ECL (0.17 eq to 0.33 eq). The water scavenger Incozol 2 (0.002 eq) was added to the GBL/ECL mixture via a gastight syringe and stirred for 1 h at room temperature under N₂ atmosphere. The sealed Schlenk tube was then immersed in a cooling bath at −10° C. during 30 min for temperature equilibration.

A separate vial was dried in the oven at 120° C. and the air was evacuated by 3 cycles of high vacuum/N₂ before sealing. It was then charged with anhydrous 2-MeTHF (resulting in a concentration of GBL+ECL of 100 M in the reaction mixture to be formed), the base anhydrous solution of potassium tert-butoxide in 2-MeTHF (2 M, 25 wt %, 0.005 eq to 0.02 eq) and the initiator indicated in table 12 (0.01 eq) via a gastight syringe. The premix base/initiator/solvent was sonicated 10 min until a homogeneous suspension was obtained. A reaction mixture was formed and the ring-opening copolymerization of GBL and ECL was initiated by addition of the premix Base/Initiator/Solvent via a gastight syringe at once.

After 4 h, the co-polymerization was quenched by addition of 40 ml of a cold (−10° C.) solution of acetic acid in DCM (5 μL/mL) before gently crushing the white solid polymer formed with a spatula. The quenched mixture was then allowed to warm to room temperature. It was then washed with distilled water (3×50 mL) in a separating funnel and then the volatiles were evaporated on rotative evaporator (40° C., until 20 mbar was reached). The remaining viscous liquid was precipitated using cold methanol (0° C.). In the case where the obtained precipitate was a viscous liquid, it was washed several times with methanol by successive centrifugation/redispersions (4000 rpm, 2 min, 10° C.) and isolated by centrifugation before drying under reduced pressure. In the case where the obtained precipitate is a solid, it was filtered, washed with cold methanol and dried under vacuum on rotative evaporator to afford the corresponding copolymer.

TABLE 12

| | | | | Conversion | CP | Isolated | |
|---|---|---|---|---|---|---|---|
| | Ratio | Mol Ratio | | GBL/ECL | GBL/ | yield | |
| Example | GBL/ECL | M^{[a]}/I/B | Initiator (I) | (%)^{[b]} | ECL^{[b]} | (%) | Comment |
| 48 | 83/17 | 100/1.0/0.5 | BnOH | 47/96 | 69/31 | 55 | Viscous |
| | | | | | | | transparent |
| | | | | | | | liquid |
| 49 | 71/29 | 100/1.0/2.0 | PEG 400 | 49/95 | 51/49 | 53 | Viscous |
| | | | | | | | transparent |
| | | | | | | | pink liquid |
| 50 | 67/33 | 100/1.0/2.0 | Ethylene | 51/94 | 47/53 | 82 | Viscous |
| | | | glycol (EG) | | | | transparent |
| | | | | | | | pink liquid |

CP = Composition of the obtained copolymer (mol GBL:mol ECL)
^{[a]}M = GBL + ECL
^{[b]}Determined by ¹H-NMR

The Copolymers Obtained in Examples 48-50 have the Following Properties:

TABLE 13

| Example | Mₙ (g/mol) | M_{w} (g/mol) | Ð | T_{g} (° C.) | T_{c} (° C.) | Tₘ (° C.) |
|---|---|---|---|---|---|---|
| 48 | 9 616 | 21 253 | 2.21 | | | |
| 49 | 12 543 | 17 761 | 1.42 | −60.6 | −15.6 | 21.3 |
| 50 | 8 300 | 12 322 | 1.48 | −61.6 | −15.0 | 21.3 |

Mₙ, M_{w} and Ð (M_{w}/Mₙ) were determined from GPC in THF.
Glass transition temperature (T_{g}), crystallization temperature (T_{c}) and melting temperature (Tₘ) were measured by DSC.

### Preparation of Poly(GBL-Co-EDL) Table 14, Example 51

The ring-opening copolymerization of γ-butyrolactone (GBL) and ε-decalactone (EDL) was performed in a flame-dried 100 mL round bottom flask. In an Argon filled glovebox, the round bottom flask was charged with GBL (100 mmol, 0.5 eq) and EDL (100 mmol, 0.5 eq) and sealed with a septum. A separate 5 mL vial was charged with the base potassium tertbutoxide (1 mmol, 0.005 eq) followed by the solvent 2-MeTHF (4 mL, resulting in a concentration of GBL+EDL of 50 M in the reaction mixture to be formed) and the diol initiator 1,4-benzenedimethanol (2 mmol, 0.01 eq) and sealed. The round bottom flask and the vial were taken out of the glovebox. The premix base/initiator/solvent was sonicated 10 min until a homogeneous suspension was obtained. The round bottom flask was immersed in the cooling bath at −10° C. After 40 min equilibration at said temperature a reaction mixture was formed and the ring-opening co-polymerization of GBL and EDL was initiated by addition of the premix base/initiator/solvent via a gastight syringe at once. After 45 minutes at −10° C., the co-polymerization was quenched by addition of 40 mL of a cold (−10° C.) solution of acetic acid in DCM (5 L/mL), and the product was immediately well homogenized with a spatula until the precipitated polymer was redissolved. The volatile constituents of the quenched reaction mixture were evaporated using a rotative evaporator (at 35° C. until 20 mbar was reached). The remaining viscous liquid was precipitated using cold methanol:water, 9:1, filtered, washed with cold methanol:water, 9:1 and dried under high vacuum (0.1 mbar) for 24 hours.

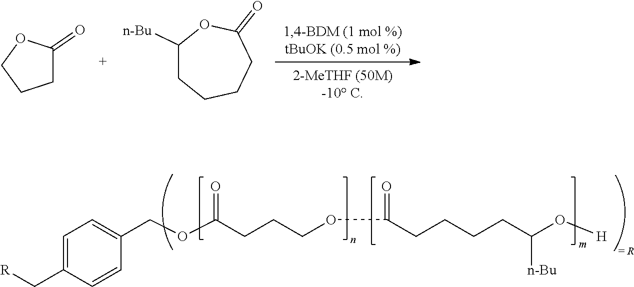

TABLE 14
(Example 51)

| | | | | | | | | CP | | |
|---|---|---|---|---|---|---|---|---|---|---|
| Initiator (I)/ | Mol Ratio | Ratio | mmol ratio | Time | T | Conv. | Conv. | GBL/ | isolated | Mₙ |
| Base (B) | M^{[a]}/I/B | GBL/EDL | GBL/EDL | (min) | (° C.) | EDL^{[b]} | GBL^{[b]} | EDL^{[b]} | yield | (g/mol)^{[c]} |
| 1,4-BDM/ | 100:1:0.5 | 50:50 | 100:100 | 45 | −10 | 76% | 92% | 56:44 | 84% | 11730 |
| tBuOK | | | | | | | | | | |

CP = Composition of the obtained polymer (mol GBL:mol EDL)
^{[a]}M = GBL + EDL
^{[b]}Determined by ¹H NMR.
^{[c]}Determined by ¹H-NMR of the pure copolymer by comparing the integration value of the signal from the initiator, 1,4-BDM [5.09 ppm] as A, with the CH₂ signal from poly-γ-butyrolactone [2.37 ppm] as B, the 2 CH₂ signal from poly-ε-decalactone [2.30 ppm] as C; the protons are written N_{A}, N_{B} and N_{C} corresponding to the number of proton integrated for the initiator A, the pGBL B and the pEDL C; and N_{OH} represent the number of —OH in the initiator (N_{OH}(diols) = 2). Mn was calculated the following equation:

$${M}_{n} \{ poly - B - co - C \} = [ ( \frac{B / Nb}{A / Na} \times {M}_{w} ( B ) ) + ( \frac{C / Nc}{A / Na} \times {M}_{w} ( C ) ) ] \times {N}_{OH} + {M}_{w} ( A )$$

1.-16. (canceled)

17. A process for the synthesis of polyesterols,
comprising the step of ring-opening co-polymerization of lactones, wherein said lactones are
(i) 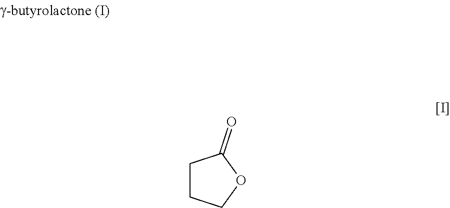
and
(ii) one or more lactones of formula (II) 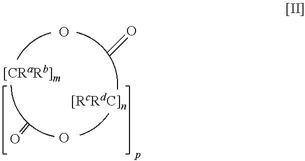
wherein
m is an integer selected from 1 to 12
n is an integer selected from 1 to 2,
each R^{a}, each R^{b}, each R^{c} and each R^{d} is independently selected from the group consisting of H and C₁-C₁₀-alkyl
p is an integer selected from 0 and 1
with the proviso that m is not 3 when p=0
wherein the ring-opening co-polymerization is carried out in the presence of
(iii) one or more bases comprising an alkali metal cation selected from the group consisting of lithium alkoxides, sodium alkoxides and potassium alkoxides and
(iv) one or more alcohols
at a temperature from −25° C. to +50° C.,
wherein the molar ratio of
the total amount of lactones (i) and (ii)
to the total amount of bases (iii) comprising an alkali metal cation
((i)+(ii)):(iii)
is 50:1 or higher,
wherein
a reaction mixture is formed and the ring-opening co-polymerization is initiated by addition of
a first premix comprising (iii) one or more bases comprising an alkali metal cation and (iv) one or more alcohols and one or more solvents to a second premix comprising (i) γ-butyrolactone (I) and (ii) one or more lactones of formula (II).

18. The process according to claim 17, wherein said one or more lactones (ii) are selected from the group consisting of ε-caprolactone, ε-decalactone, δ-valerolactone, β-propiolactone, lactide and glycolide.

19. The process according to claim 17, wherein the base (iii) comprising an alkali metal cation, or one or more or all of the bases (iii) comprising an alkali metal cation are selected from the group consisting of lithium methoxide, sodium methoxide, potassium methoxide, lithium tertbutoxide, sodium tertbutoxide, potassium tertbutoxide, lithium benzylalcoholate, sodium benzylalcoholate, potassium benzylalcoholate, di-potassium benzenedimethanol and disodium benzenedimethanol.

20. The process according to claim 17, wherein the alcohol (iv) or one or more or all of the alcohols (iv) are selected from the group consisting of ethyleneglycol, diethyleneglycol, polyethyleneglycol, 1,2-propanediol, dipropyleneglycol, polypropyleneglycol, 1,3-propanediol, 1,4-butanediol, neopentylglycol, polytetra-methyleneglycol, 1,5-pentanediol, 1,6-hexanediol, glycerol, trimethylolpropane, trimethylolethane, pentaerythritol, mannitol, sorbitol, xylitol, threitol,
and benzylic alcohols according to formula (III) 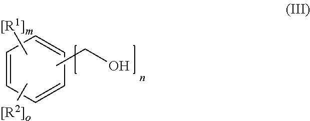
wherein
n is an integer from 1 to 4, preferably 2 or 3
m is an integer from 0 to 3,
is 0 or 1
m+n+o≤6;
R¹ and R² are independently of one another selected from the group consisting of
F, Cl, Br, OH, CN, NH₂, NO₂,
C₁-C₁₀-alkyl
C₃-C₁₀-cycloalkyl,
C₃-C₁₀-heterocyclyl comprising at least one heteroatom selected from N, O and S,
C₅-C₁₄-aryl,
C₅-C₁₀-heteroaryl comprising at least one heteroatom selected from N, O and S,
wherein said C₁-C₁₀-alkyl, C₃-C₁₀-cycloalkyl, C₃-C₁₀-heterocyclyl, C₅-C₁₄-aryl, resp.
C₅-C₁₀-heteroaryl optionally has one or more further substituents selected from the group consisting of: F, Cl, Br, OH, CN, NH₂ and C₁-C₁₀-alkyl,
wherein the benzylic alcohol according to formula (III) is preferably selected from the group consisting of benzylic alcohol, 1,4-benzenedimethanol, 2,6-dichlorobenzylalcohol, 4-methylbenzylalcohol and 2,4,6-trimethylbenzylalcohol.

21. The process according to claim 17, wherein the ring-opening co-polymerization is carried out at a temperature in the range of from −25° C. to +30° C.

22. The process according to claim 17, wherein the molar ratio of
the total amount of lactones (i) and (ii)
to the total amount of bases (iii) comprising an alkali metal cation
is in the range of from 100:1 to 800:1.

23. The process according to claim 17, wherein the molar ratio of
the total amount of bases (iii) comprising an alkali metal cation to
the total amount of OH groups (v) in the alcohols (iv)
(iii):(v)
is in the range from 1:6 to 12:1.

24. The process according to claim 17, wherein the molar ratio of
(i) γ-butyrolactone (I) to
the total amount of said lactones (ii)
is in a range of 5:95 to 95:5.

25. The process according to claim 17, wherein the ring-opening co-polymerization is carried out in a solvent or one or more solvents, wherein
said solvent or one or more or all of the solvents are selected from the group consisting of aliphatic hydrocarbons, aromatic hydrocarbons, ethers, esters, N,N-dialkylamides, dialkylsulfoxides and nitriles,
wherein preferably the solvent or one or more or all of the solvents are selected from the group consisting of dichloromethane, toluene, 2-methyl-tetrahydrofurane, 1,4-dioxane, glyme, diglyme, ethyl acetate, dimethylformamide, dimethylformamide, dimethylsulfoxide and acetonitrile and mixtures thereof.

26. The process according to claim 17, further comprising prior to the ring-opening copolymerization a step of drying of the lactones (i) and (ii) by adding a drying agent, and optional separation of the dried lactones (i) and (ii) from the drying agent, wherein the drying agent is preferably selected from the group consisting of
CaH₂,
tosyl isocyanate,
and oxazolidines
wherein the oxazolidine is preferably selected from the group consisting of oxazolidines of formula (IV), oxazolidines of formula (V), and oxazolidines of formula (VI) 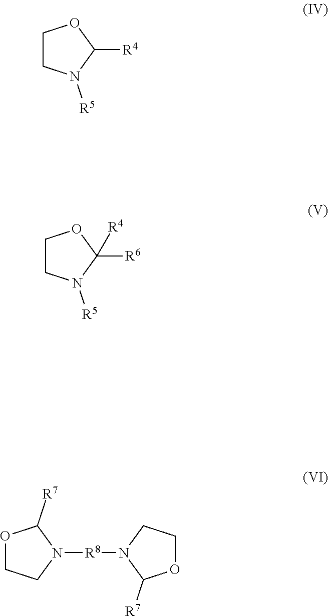
wherein R⁴, R⁵, R⁶, and R⁷ are independently of one another selected from the group consisting of H— and C₁-C₁₀-alkyl
and R⁸ is a bridging unit comprising 1 to 20-CH₂-units and optionally one or more moieties selected from the group consisting of —NH—, —O—, —CO—, —COO— and —NH—COO—.

27. The process according to claim 17, wherein the lactones (i) and (ii) have a water content of 0.1 wt % or lower, preferably 0.05 wt % or lower, and most preferably 0.01 wt % or lower, as measured by Karl-Fischer-titration.

28. The process according to claim 17, further comprising the step of quenching the ring-opening co-polymerization by adding a quenching solution comprising one or more acids and one or more solvents,
wherein preferably
said one or more acids are selected from the group consisting of hydrohalogenic acids, oxoacids of Cl, S, N, P and B, alkylsulfonic acids, arylsulfonic acids, mono-, di- and trifunctional carboxylic acids, and/or
said one or more solvents are selected from the group consisting of halogenated aliphatic and aromatic hydrocarbons, ketones, ethers, dialkylcarbonates, dialkylsulfoxides and nitriles, and/or
said quenching solution has a temperature in the range of −25° C. to +50° C.

29. The process for the synthesis of polyesteroles according to claim 17, comprising the steps of
(A) ring opening co-polymerization of
(i) γ-butyrolactone (I) and
(ii) one or both of ε-caprolactone, ε-decalactone, and δ-valerolactone in the presence of
(iii) one or more bases comprising an alkali metal cation selected from the group consisting of lithium tertbutoxide, sodium tertbutoxide, potassium tertbutoxide, di-potassium benzenedimethanol and di-sodium benzenedimethanol, and
(iv) one or more alcohols selected from the group consisting of 1,4-benzenedimethanol, 1,3,5-benzenetrimethanol, glycerol, trimethylolethane, pentaerythritol, benzyl alcohol, ethyleneglycol, polyethyleneglycol and 1,5-pentanediol,
at a temperature from −25° C. to +30° C.,
wherein the molar ratio of γ-butyrolactone (I), ε-caprolactone and δ valerolactone to the total amount of bases (iii) comprising an alkali metal cation
((i)+(ii)):(iii)
is 100:1 to 800:1 and
the molar ratio of the total amount of bases (iii) comprising an alkali metal cation to the total amount of OH groups (v) in the alcohols (iv)
(iii):(v)
is in the range of from 1:2 to 8:1 and
wherein the molar ratio of γ-butyrolactone (i) to the total amount of ε-caprolactone and δ-valerolactone (ii) is in a range of from 85:15 to 15:85 and
wherein the ring-opening co-polymerization is carried out in a solvent selected from the group consisting of dichloromethane, toluene, 2-methyl-tetrahydrofurane, 1,4-dioxane, glyme, diglyme, ethyl acetate, dimethylformamide, dimethylformamide, dimethylsulfoxide and acetonitrile and mixtures thereof, and
wherein γ-butyrolactone (I), ε-caprolactone and δ-valerolactone have a water content of 0.01 wt % or lower, as measured by Karl-Fischer-titration, and
(B) quenching the ring-opening co-polymerization by adding a quenching solution comprising an acid and a solvent, wherein
said acid is selected from the group consisting of hydrochloric acid, perchloric acid, nitric acid, sulfuric acid, phosphoric acid, boric acid, formic acid, acetic acid, acrylic acid, oxalic acid, propionic acid, lactic acid, citric acid, methanesulfonic acid and toluenesulfonic acid
said solvent is selected from the group consisting of dichloromethane, trichloromethane, deuterotrichloromethane, 1,2-dichlorethane, 1,1,2,2-tetrachlorethane, chlorobenzene, 1,4-dioxane, anisole, dimethylether, acetone, acetophenone, dihydrolevoglucosenon, dimethylcarbonate, diethylcarbonate, dimethylsulfoxide, acetonitrile and mixtures thereof,
said quenching solution has a temperature in the range of −25° C. to +50° C.

30. The process according to claim 17,
wherein after the ring-opening co-polymerization is initiated,
one or more further portions of a premix comprising (iii) said one or more bases comprising an alkali metal cation and (iv) said one or more alcohols and one or more solvents as in said first premix and/or
one or more further portions of a premix comprising (i) γ butyrolactone (I) and (ii) said one or more lactones of formula (II) as defined above and optionally one or more solvents as in said second premix,
are added.

31. A method of providing kit comprising
one or more bases (iii) comprising an alkaline metal cation and
one or more alcohols (iv)
in a process according to claim 17.

32. Polyesterol obtained by a process according to claim 17.
